(19) United States
(12) Patent Application Publication
(10) Pub. No.: US 2014/0012726 A1
(43) Pub. Date: Jan. 9, 2014

(54) SYSTEM AND METHOD THAT FACILITATES TRANSACTIONS BETWEEN PHYSICAL GOLD HOLDINGS AND COMMERCIAL PAYMENT SYSTEMS

(71) Applicant: Christian Frederick Kruse, San Francisco, CA (US)

(72) Inventor: Christian Frederick Kruse, San Francisco, CA (US)

(21) Appl. No.: 13/926,948

(22) Filed: Jun. 25, 2013

Related U.S. Application Data
(60) Provisional application No. 61/664,333, filed on Jun. 26, 2012.

(51) Int. Cl. G06Q 40/04

(52) U.S. Cl. CPC G06Q 40/04
USPC 705/37

(57) ABSTRACT

A computer-implemented method for facilitating financial transactions in one or more precious metals using a debit card secured by the one or more precious metals. The computer-implemented method includes the steps of using an Internet website accessible via a computer or a mobile device, wherein the Internet website is configured to perform the step of: providing a first customer with a first balance of a first customer account; wherein the first balance is provided in weight of the one or more precious metals provided by the first customer.

### CROSS-REFERENCE TO RELATED APPLICATIONS

This application is a non-provisional application of U.S. provisional application 61/664,333, titled “Gold-Debit-Card” and filed Jun. 26, 2012, which is hereby incorporated by reference in its entirety.

### FIELD OF INVENTION

The present invention provides a system and method for facilitating transactions in one or more precious metals, using a debit card backed by the one or more precious metals.

### BACKGROUND

Currently, money is valued primarily based upon the perceived strength of its underlying economy and banking system. Individuals have increased their holdings of gold and other precious metals due to uncertainty with the international banking system as well as the global economic downturn. A precious metal such as gold is in high demand as a store of value especially during periods of economic downturn; however, it is difficult to conduct financial transactions in precious metals such as gold. Currently, in order to use gold to conduct a financial transaction, individuals generally have to liquidate larger than needed increments of gold, obtain cash from the sale, and use that cash to conduct financial transactions. This is time-consuming and inefficient. Additionally, sometimes people like to maintain their wealth in gold. This is especially true during an economic downturn, when, for example, the value of their currency is down. It would be beneficial for individuals to be able to liquidate small amounts of gold when needed, rather than large amounts, in order to maintain their wealth in gold (or other precious metal) rather than their local currency. Accordingly, there is a need for a method of conducting financial transactions using precious metals, such as gold, in an efficient manner using existing commercial banking systems.

### SUMMARY OF PREFERRED EMBODIMENTS

A method for facilitating financial transactions in one or more precious metals using a debit card secured by one or more precious metals is provided. Preferably, the method includes the steps of providing an Internet website accessible by a customer via a computer or a mobile device; providing an Internet website accessible by a GDC employee via a computer or a mobile device; establishing a customer account on the Internet website accessible by the customer; inspecting one or more precious metals provided by the customer; and/or crediting the customer account on the Internet website accessible by the customer to reflect a weight or a cash value of the one or more precious metals provided by the customer. In one aspect, the method may compromise the step of updating the customer account on the Internet website accessible by the customer to reflect the cash value of the one or more precious metals provided by the customer. Preferably, the one or more precious metals are gold and wherein the weight of gold is provided in milligrams. Preferably, the cash value of gold is adjusted daily based upon a prior day's spot price. In one aspect, the method may compromise the step of providing the customer with a debit card, wherein the cash value of the debit card is adjusted daily based upon the prior day's spot price. In one aspect, the method includes the step of providing the customer with the cash value of the debit card daily on the Internet website accessible by the customer. In one aspect, the method further includes the step of updating the customer account on the Internet website accessible by the customer to reflect a financial transaction with the debit card. In one aspect, the method further includes the step of providing live feed from London Bullion Market Association on the Internet website accessible by the customer, or the Internet website accessible by the GDC employee. In one aspect, the method includes the step of updating the customer account on the Internet website accessible by the customer, or the Internet website accessible by the GDC employee, to reflect a sweep account at a financial institution. In one aspect, milligrams of gold are deducted from the customer account after the financial transaction with the debit card. Preferably, the amount of gold deducted is based upon a current day's spot price or a prior day's spot price. In one aspect, the method further compromises the step of notifying the customer about the amount of gold deducted from the customer account based upon the financial transaction. In one aspect, the milligrams of gold are deducted from the customer account after the financial transaction with the debit card. Preferably, the amount of gold deducted is based upon a current day's spot price or a prior day's spot price. In one aspect, the method further compromises the step of notifying the customer about the amount of gold deducted from the customer account based upon the financial transaction.

In one embodiment, a system for facilitating financial transaction with one or more precious metals is provided. The system includes an Internet website accessible via a computer or a mobile device for facilitating financial transaction with one or more precious metals; a customer account database compromising one or customer accounts, wherein each customer account comprises one or more weights of each precious metal provided by the customer; a financial transaction database, wherein the financial transaction database compromises one or more debits. Preferably, the one or more precious metals are gold. In one aspect, the one or more debits are listed as a weight of gold, wherein the weight is milligrams. Preferably, the one or more debits are aggregated daily. In one aspect, the system may further compromise a debit card secured by the gold provided by the customer.

In one embodiment, a computer-implemented method for facilitating financial transactions in one or more precious metals using a debit card secured by the one or more precious metals is provided. The method includes the steps of using an Internet website accessible via a computer or a mobile device, wherein the Internet website is configured to perform the steps of: providing a first customer with a first balance of a first customer account; wherein the first balance is provided in weight of the one or more precious metals provided by the first customer. In one aspect, the Internet website is configured to perform the step of receiving information regarding the first customer's use of a first debit card, wherein the first debit card is secured by gold. In one aspect, the Internet website is configured to perform the step of updating the first balance to a second balance, wherein the second balance reflects a first debit with the debit card, wherein the second balance is provided in milligrams of gold. Preferably, the second balance is determined by value of gold on the day the first debit occurred. Preferably, the Internet website is configured to provide a second customer with a third balance of a second customer account; wherein the third balance of the second customer account is provided to the second customer in milligrams of gold. Preferably, the step of updating the third balance to a fourth balance, wherein the fourth balance reflects a second debit with a second debit card, wherein the fourth balance is provided to the second customer in milligrams of gold. In one aspect, the Internet website is configured to perform the step of aggregating the first debit and the second debit to form a total; wherein the total is converted to milligrams of gold. In one aspect, the Internet website is configured to determine an amount of gold to be sold daily, wherein the amount is equal to the total of the first debit and the second debit. In one aspect, the Internet website is configured to update the first customer account to reflect an additional gold provided by the first customer; wherein a value of the additional gold is determined by date of credit of the additional gold to the first customer's account; wherein the first customer account is credited in milligrams of gold.

In one embodiment, a computer-implemented method of facilitating one or more financial transactions in gold is provided. The method includes the steps of using an Internet website accessible by a computer or mobile device; providing gold; establishing a customer account; and receiving a first balance of the customer account in milligrams of gold.

In one embodiment, a computer-implemented method of conducting financial transactions in small amounts of gold is provided. The method includes the steps of using an Internet website accessible via a computer or a mobile device; wherein the Internet website is configured to: update a customer account to reflect a debit with a debit card; and determine an amount of gold to sell daily, wherein the amount of gold is equal to an amount of the debit.

### BRIEF DESCRIPTION OF DRAWINGS

The invention may be more readily understood by referring to the accompanying drawings in which:

FIG. 1 is a block diagram of a system and method of facilitating transactions in gold in accordance with a preferred embodiment of the present invention

FIG. 2 is a block diagram of a computer system that may be used for implementing the system and method of facilitating transactions in gold of FIG. 1 configured in accordance with a preferred embodiment of the invention;

FIG. 3 is a network diagram illustrating a network of computer systems that may be used for implementing the system and method of facilitating transactions in gold configured in accordance with a preferred embodiment of the invention;

FIG. 4 is a block diagram of the system and method of FIG. 1; configured in accordance with a preferred embodiment of the invention;

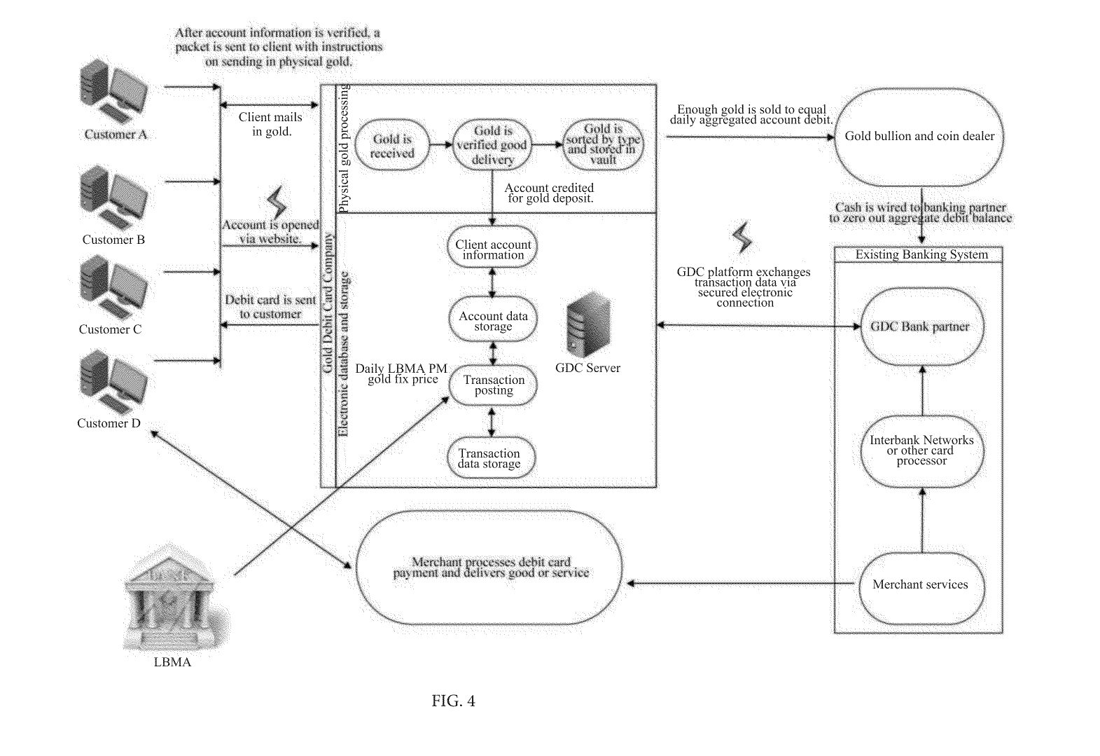

Like numerals refer to like parts throughout the several views of the drawings.

### DETAILED DESCRIPTIONS OF PREFERRED EMBODIMENTS

### Definitions

“Configured to,” means adapted for, employed, implemented, or programmed, as well as any combination thereof, to carry out some process, function, step or routine.

“Consumer” refers to an individual or business that uses, or intends to use, the subject invention to make financial transactions backed by one or more precious metals. “Consumer” and “customer” as used herein are interchangeable.

“Computerized electronic server” or “electronic server” may refer to a website, web-enabled software, and/or any other electronic medium. Preferably, the computerized electronic server is encrypted. For example, it may be encrypted using SPAC software, or any other application for file encryption or sharing. It may also refer to a local area network or a cell phone network.

“Data messages” refer to data or information generated, sent, received or stored by electronic means.

“Debit” may refer to a record of indebtedness and/or a charge against a bank account and/or an amount of a financial transaction.

“GDC” refers to gold debit card, i.e., a debit card backed by, or secured by, gold.

“GDC agency” refers to the individual, business, agency that facilitates the consumer's ability to obtain a debit card backed by his or her precious metal(s).

“GDC employee” means an individual or other entity, such as a business, that works for, or otherwise assists, the GDC agency in facilitating consumer financial transactions in precious metals such as gold. The GDC employee as used herein may be an independent contractor and not necessarily an employee.

“GDC consumer interface” refers to the consumer graphical user interface on an Internet website.

“Financial transaction” refers to the exchange of an item, good or service for money or other consideration.

“Financial institution” refers to an entity, such as a bank, which provides financial services for its clients or members.

“User” refers to any entity which accesses information through a communication network, including, but not limited to the Internet, as well as any individual, consumer or entity that purchases or makes a decision to purchase a product or is contemplating the purchase of a product.

“Internet website” is interchangeable with “website” and “Internet.” It may also refer to any electronic medium capable of data transmission.

“Merchant” refers an individual or business entity, such as a retailer, that sells commodities, products or services to users.

“Merchant device” refers to a checkout system or point of sale terminal used by merchants to track and complete financial transactions with users. A scanner may be integrated into the merchant device or may be external to the merchant device and can provide an interface and data connection to the mobile device.

“Precious metal” refers to gold, silver, diamond, palladium, platinum, mixtures thereof, or the like. It may also refer to jewelry that is a comprised of one or more precious metals. Accordingly, according to the system and methods of the invention, jewelry may be given a cash value, and that cash value may be credited to the consumer's account.

“Sweep account” refers to an account set-up by a financial institution wherein the funds are automatically managed between a primarily cash account and secondary investment accounts. “Sweep account” may also refer to an escrow account, or the like.

The present invention is directed to a system and method that facilitates transactions between physical precious metal holdings and commercial payment systems. Preferably, the system and method of the present invention is facilitated by the use of a communications network such as an Internet website accessible via a device capable of displaying an Internet website such as a computer or processor, mobile device, or the like. Preferably, the Internet website displays one or more graphical user interfaces (referred to herein singularly and plurally as “GUI”).

A graphical user interface is a type of user interface that allows users to interact with programs in more ways than simply typing. The user is generally able to access the GUI by entering a secure website on the Internet, or any other electronic medium. The GUI may be accessed by any web-enabled device, such as a computer or mobile device. Preferably, the GUI is displayed on an Internet website accessible via a computer.

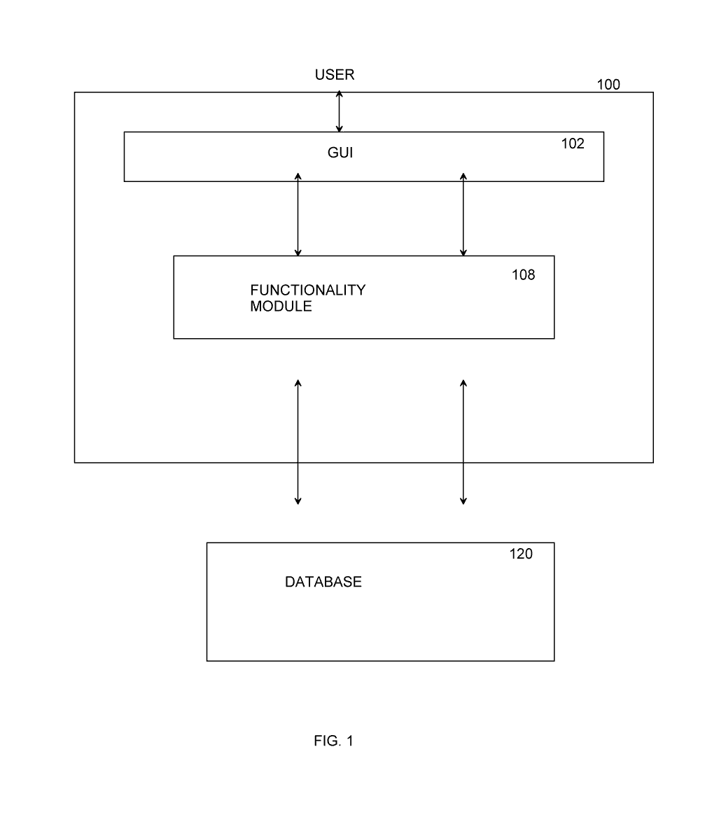

FIG. 1 is a block diagram of a system 100 of facilitating transactions between physical precious metal holdings, such as gold holdings, and existing commercial payment systems. The system 100 includes a graphical user interface (GUI) 102 coupled to a functionality module 108. The GUI 102 provides a user with access to the information stored in a database 120 using the functionality provided by the functionality module 108. As further described below, in one embodiment, the database 120 stores information in one or more related databases that are logically grouped by predetermined areas. These areas may be, for example, consumer accounts, transaction records, financial institution credits to merchant, and the like. As used herein, “database” should be understood to cover reference to a single database or a collection of databases. The database may be on a virtual server. For example, the database may be on the cloud. In other embodiments, information may be stored or arranged using a variety of data storage software and hardware techniques known to those of ordinary skill in the art of database programming. For example, one database system that may be used with the present invention is the SQL Server system as offered by Microsoft Corp. Other data storage systems, such as those based on Oracle Database products offered by Oracle Corporation or the MySQL database server offered by MySQL AB, may be used. These data storage systems run on a variety of hardware platforms, including those based on the microprocessors offered by Advanced Micro Devices2, Inc., or Intel Corp. In addition, the system may include a software system.

Referring to FIG. 1, database 120 is preferably accessible by the functionality provided by functionality module 108 in system 100. The user accesses functionality module 108 in system 100. The user accesses functionality module 108 through GUI 102, as described herein. For example, functionality module 108 may be a software system for updating consumer transaction history. Subsequently, the consumer transaction history may be displayed on GUI 102.

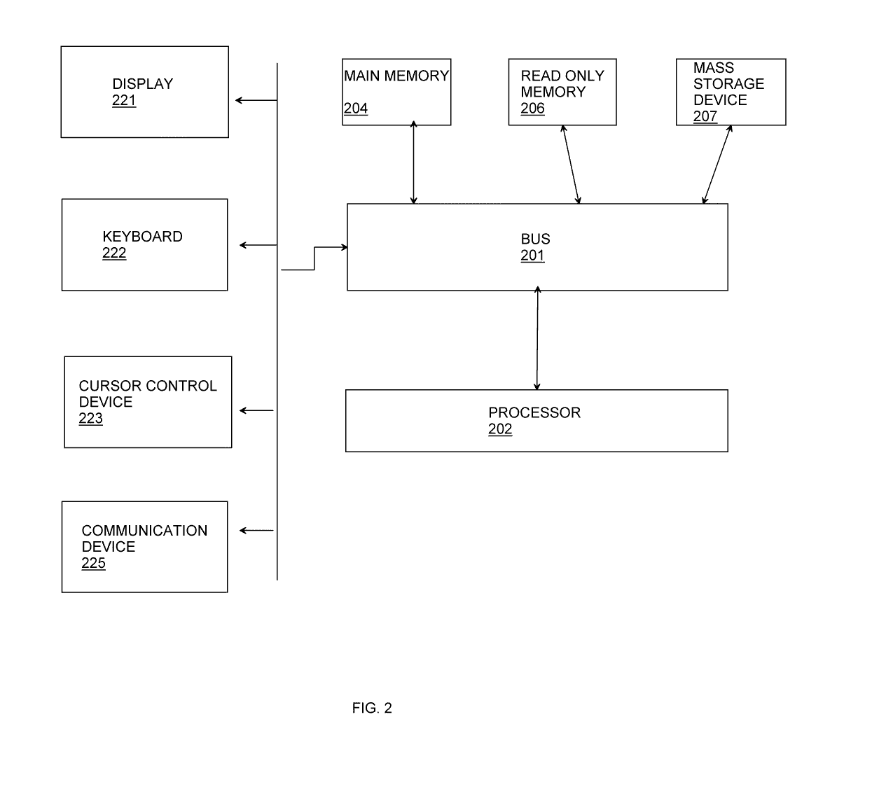

FIG. 2 illustrates an example of a computer system 200 in which the features of the present invention may be implemented. The computer system 200 may include a bus 201 for communicating information between the components in the computer system 200, and a processor 202 coupled with the bus 201 for executing software code, or instructions, and processing information. The computer system further compromises a main memory 204, which may be implemented using random access memory (RAM) and/or other random memory storage device, coupled to the bus 201 for storing information and instructions to be executed by the processor 202. The main memory 204 also may be used for storing temporary variables or other intermediate information during the execution of instructions by the processor 202. The computer system 200 may also include a read only (ROM) and/or other static storage device coupled to the bus 201 for storing static information and instructions for the processor 202.

Another type of user input shown in FIG. 2 is a cursor control device 223, such as a conventional mouse, touch mouse, trackball, track pad, or other type of cursor direction keys for communicating direction information and command selection to the processor 202 and for controlling movement of a cursor on the display 221. Although not illustrated, the computer system 200 may optionally include video, camera, speakers, sound card, and the like. Various types of input devices, including, but not limited to, the input devices described herein, may allow the user to provide command or input to the computer system 200. For example, in the various descriptions contained herein, reference may be made to the user “clicking,” “selecting”, or “inputting” and any other grammatical versions thereof, one or more items in a user interface. These should mean that the user is using one or more input devices to accomplish the input.

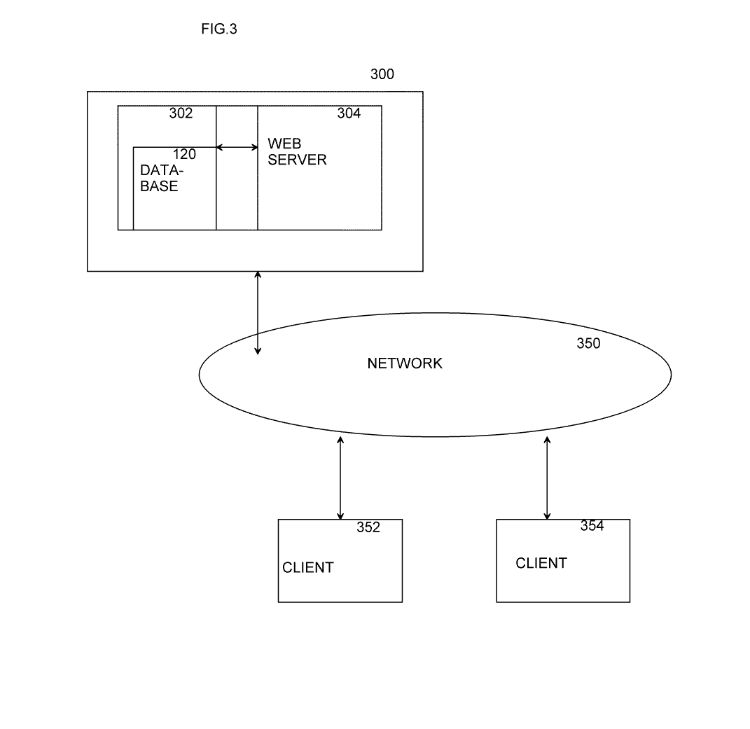

In accordance with one embodiment, FIG. 3 illustrates a computer network including a server system 300 having a database server 302 for storing a database 120 and a web server 304 that stores the instructions necessary to access and present the information from, as well as store information into, the database 120. The user, using a client computer such as a client 352 and a client 354, may access server system 300 through a network 350. Other systems, such as those belonging to a manufacturer, may also be coupled to the server system 300. In the illustrated embodiment, the network 350 represents a variety of networks that may include one or more local area networks as well as wide area networks. The functionality provided by the database server 302, the web server 304, the client 352, and the client 354 as well as by the manufacturer, may be implemented using a computer system having the characteristics of the computer system 200 described herein. It should be noted, however, that specific implementation of the computer system or systems used to describe the present invention is not to be limiting unless specifically noted. For example, the functionality provided by the database server 302 and the web server 304 may be offered by one computer system. Further, the functionality provided by the database server 302 and web server 304 may be redistributed over several computers.

In a preferred embodiment, the user (i.e., the consumer) may interact with the information stored in the database 120 through the GUI. In the following description, the GUI 102 is implemented using one or more web pages (which may be referred to herein as “pages,” “screens,” or “forms”) provided by the web server 304 accessible by the user using any Internet web browser software, such as the Internet Explorer browser provided by Microsoft Corp., on a client computer such as the client 352 or mobile device. In another embodiment, one or more custom software programs can be created to implement the system described herein. Of course, the web server 304 may itself have browser software installed on it so as to be accessed by the user. Further, throughout the description of the various embodiments of the invention herein, references are made to the user performing such actions as selecting buttons or clicking on, executing searches or updates on the database 120. In one preferred embodiment, these requests are generated by the user interacting with the browser. Preferably, the one or more web pages described herein may include a form interface (e.g., a drop down menu, a radio button selection, etc.). Once the user has provided such a selection, the user may select a button or a link on the web page to request an update of the database 120 with the information. The browser will send the web server 304 a link that includes the information (i.e., the user's selection) being sent as well as a request to update the database 120.

Throughout the description of the various embodiments of the invention described herein, references are made to the website or interface “updating” or any grammatical version thereof. This reference preferably means that the system is taking note of the new information and updating, for example, the consumer account database (or any other database), regarding new information. These “updates” may be triggered manually, automatically, and/or passively. As used herein, “manually,” or any grammatical version thereof, refers to one or more individuals interacting with the website to update, for example, a consumer account. For example, a GDC employee may input gold value provided by a customer in a customer's account. The GDC employee may be provided with a button to “update” or “refresh” the customer's account to reflect the inputted gold value. As used herein, “automatically,” or a grammatical version thereof, refers to a website updating, for example, a consumer account on its own, i.e., when a consumer conducts a transaction at a merchant with GDC. The website may “update” to reflect this transaction.

In one embodiment, the system and methods of the present invention may be accessible via the website through cloud computing (i.e., a virtual server). For example, cloud computing may provide a secure server for a consumer, GDC employee, financial institution, and the like, web-enabled GUI access via a virtual server.

Cloud computing may serve to store and operate all of the GUIs, software, and databases. In other embodiments, cloud computing may not be used, or may be partially used. In this instance, the server may not be a virtual server. As such, the server may be a physical computer having Internet access.

The present invention is directed to a system and method of facilitating transactions between physical precious metal holdings and, preferably, existing commercial payment systems. An exemplary precious metal discussed below is gold. It is to be understood, however, that the invention is not limited to facilitating transactions in gold. The invention may facilitate transactions with any precious metal, such as silver, and/or jewelry, without departing from the scope of the present invention.

### Exemplary Log-In Screen

A consumer may be directed to the GDC website. If the consumer has never logged in to the website before, the consumer may be directed to register. If the consumer has already registered, the consumer may be directed to log-in. To log-in, a consumer may enter or input a valid username and password into respective username (or email) and password fields. The log-in screen may provide a link if the consumer forgets his or her username and/or password. Upon entering a username and password, the user may then select a login button to proceed. The GDC website may identify user as a consumer, and not a GDC employee. As such, the GDC consumer home page and/or customer GUI may be displayed upon log-in.

### Exemplary GDC Consumer Interface or GDC Customer GUI

The GDC consumer interface (or the website) may be configured to provide the consumer with a number of options to select. For example, the consumer may be provided with, or the website may be configured with, a “help” feature or tool in the form of a drop down menu of topics, or the like. This “help” feature may include a live chat service. Further, the consumer may be provided with a screen to enter his or her GDC account information if he or she has not already done so. This account information may include identifying information, such as residence address (preferably including country of residence). The system may thereby update to reflect the additional account information. Further, the consumer may be provided with a feature or tool to input preferred or default currency preference (i.e, currency in country of residence), such as a drop down menu, online form, or the like. The consumer account information may be located in a consumer account database. The consumer may be able to update his or her account information at any time.

### Viewing GDC Account

At or from the GDC consumer homepage or GDC consumer interface, the consumer may be provided with the option of viewing his or her GDC account online to determine the weight of gold or other precious metal (preferably in milligrams) within the account. Preferably, the value of the customer account is based on the weight of the gold in milligrams (not based upon its cash value), and the balance is presented in milligrams. It is to be understood, however, that the consumer may be able to convert the weight of the gold in his or her account to its cash value at any time. The cash value of the customer account may fluctuate based upon the value of gold (i.e., the value of gold per ounce or troy ounce), on any given day. For example, the cash value of the customer account may be determined in real time based on the prior day's gold price or the transaction day's spot price. As such, the cash value may vary by day and may be updated day by day or even more frequently. In this regard, the consumer may be provided with a tool or feature to determine the cash value of his or her customer account at any time. For example, the consumer may be provided with a drop down menu or calendar to select a particular day, and may be provided with an “update” or “refresh” button to update/refresh the cash value of his or her account based upon the value of gold on the selected day. Additionally, the consumer may be provided with a live feed from London Bullion Market Association (LBMA) to assist in determining the cash value of his or her gold holdings and/or the value of gold on any given day. In other embodiments, the consumer may be provided with, in lieu of, or in addition to, live feed from LMBA, the consumer may be provided with live feed and/or updates from US Comex (part of CME, or Chicago Mercantile Exchange Group); and/or Shanghai Gold Exchange, and the like.

Additionally, the consumer may be provided with a tool or feature at any stage of the process to select “default” currency type. For example, a U.S. customer may select the dollar as the default currency type (as well as have a “sweep” account with a U.S. bank, as discussed further below). If, however, the consumer is situated temporarily for work in Great Britain, the costumer may be able to use his or her debit card in Great Britain. In this regard, the consumer may use gold to conduct transactions, however small, overseas. Accordingly, the consumer may be able to utilize a single customer account to conduct financial transactions in different countries.

Further, the consumer may be provided with (and the website may be configured to provide the customer with) a tool or feature, such as an account/transaction history button on the website, to review transactions made with his or her GDC debit card. Preferably, every time the consumer makes a financial transaction with his or her debit card on any given day, his or her customer account is updated (i.e., to reflect each financial transaction, such the name of the merchant where the transaction was made and its amount in local currency). Preferably, the customer account balance is provided in milligrams of gold (or other precious metal). At the end of any given day, each customer's financial transactions may be aggregated (added together), and a total end balance for the customer account created in, preferably, weight of gold (preferably milligrams). This is done by determining the price (in local or selected currency) per milligram on the day of the financial transaction. The cash value of the customer account (prior to the financial transactions conducted that day) may be subtracted by the amount of the one or more financial transactions conducted that day (to obtain a final amount in local or selected currency). That amount may be used to determine the final weight of gold in milligrams left in the customer account at the end of the day. As can be seen, the weight of gold remaining in the customer account fluctuates based upon the value of gold per troy ounce on any given day. In other embodiments, other methods to determine the weight of gold may be used.

### Replenishing GDC Account

At or from the GDC consumer homepage and/or GDC consumer GUI, the consumer may be provided with (and the website may be configured to provide) the option of adding to/replenishing his or her account by, for example, clicking on an “add/replenish account” tool or feature on the webpage itself. Selecting this tool or feature may provide the consumer with one or more methods of physically transferring gold to the GDC agency or its partner repository. For example, the consumer may request a gold packet to be mailed or sent electronically to him or her (i.e., an envelope addressed to the GDC agency with instructions for use) if he or she does not already have one. Upon receipt of the gold packet, the consumer may deposit certain amount of gold into the packet and mail it back to the GDC agency. Preferably, the physical gold (or other precious metal) that the customer provides is held outside the banking system. The “add/replenish” account tool or feature may provide the consumer with the option of notifying the GDC agency of the impending gold delivery (i.e., notifying GDC agency of the Fed Ex tracking numbers and the like). Furthermore, the consumer may be provided with a tool or feature to confirm GDC agency receipt of the gold. For example, the consumer may receive an email confirming receipt of the gold. In other embodiments, the consumer may be provided with a tool or feature on the GDC consumer website to identify GDC agency partner repositories that are located nearby. Partner repositories are essentially entities that may inspect the gold for good delivery. The consumer may physically carry the gold to this partner repository, which will in turn inspect the gold. In yet other embodiments, the GDC agency, or partner repository, may, upon request by the consumer, personally pick-up the gold and deliver it to the GDC agency or partner repository for inspection. In yet other embodiments, the gold (or other precious metal) that the customer provides is not held outside the banking system.

Preferably, the GDC agency or partner repository inspects the gold for good delivery (i.e., authenticity). Once good delivery is verified, the consumer may receive an email notification and/or may receive a notification, such as a data message, within his or her online account with the GDC consumer GUI.

### Exemplary GDC Employee Interface or GDC Employee GUI

The GDC employee interface may be the same as, or different from, the consumer interface. It is to be understood, however, that there are certain tools or features of the GDC employee interface that are not accessible by the ordinary consumer. This is, for example, to protect the privacy of each consumer. For example, the initial log-in screen may be the same. If, however, a GDC employee logs in, as opposed to a consumer, and the website recognizes the GDC employee as a GDC employee, the GDC employee may be directed to the GDC employee interface, as opposed to the GDC consumer interface and/or may be provided with additional features or tools that are not available on the GDC consumer interface. In this regard, access is controlled to authorized individuals. In some embodiments, the GDC employee GUI may be an altogether different website.

### Exemplary Log-In Screen

In one embodiment, if the GDC employee logs-in to the GDC employee GUI. If the GDC employee has never logged in before, the GDC employee may be directed to register. The GDC employee's registration process may require some level of authentication. If the GDC employee has already registered, the GDC employee may log-in. To log-in, the GDC employee may enter a valid username and password into the respective username (or email) and password fields. The log-in screen may provide a link for the GDC employee if the GDC employee forgets his or her username or password. Upon entering a username and password, the user may then select a login button to proceed. The GDC website may thereby identify the user as a GDC employee, and not a consumer. As such, the GDC employee homepage and/or GDC website may be displayed upon log-in. The GDC employee homepage and/or GDC employee interface is preferably a secure website that is only accessible by authorized individuals. In other embodiments, the GDC employee may use other methods of authentication in lieu of, or in connection with, entering a username/pas sword. For example, the GDC employee may be asked a series of questions, and/or asked to swipe a card, or the like for authentication purposes in lieu of, or in addition to, logging in.

### Viewing GDC Accounts

The GDC employee homepage or website may provide the GDC employee with (and be configured with) a number of tools or features. The tools or features provided may differ depending on the type of GDC employee. For example, the GDC employee may be provided with a tool such as a link or button on the GD website that allows him or her to have access to consumer accounts and/or the consumer account database, and/or the transaction account database, and/or a tool that allows him or her to electronically communicate with the consumer via data messages.

### Replenishing the GDC Account

The GDC employee may be provided with a tool or feature on the website, such as a link, button, or the like, to track consumer accounts at various stages of processing. Certain customer accounts may be flagged or otherwise grouped together. For example, customer accounts that have requested gold packets may be flagged or otherwise noted and/or the GDC employee may be electronically notified when consumers request gold packets. The GDC employee may thereby be able to send the consumer a gold packet electronically or via mail. Further, the GDC employee may be a provided with a feature (i.e., a “need to inspect” or other notification on the customer account alerting the GDC employee) to identify consumer accounts that are “pending,” i.e., those accounts wherein gold has been delivered to GDC or its partner repository, but wherein the gold has not been inspected for good delivery. Once the gold has been inspected for good delivery, the consumer account may be “flagged” or otherwise noted or updated. The GDC employee may thereby be able to electronically communicate with the consumer that his or her gold has been inspected for good delivery and/or may update the customer account to reflect the same.

### Value of Gold

The GDC employee may be provided with a tool or feature such as live feed and/or updates from the London Bullion Market Association (LBMA); U.S. Comex (part of the CME group); and/or Shanghai Gold Exchange, regarding daily gold spot price on the GDC website to determine the value of gold based upon, for example, the prior day's spot price. With the help of this tool or feature, the GDC employee may be able to electronically credit the consumer's GDC account in, for example, milligrams of gold, based on that day's spot price. The website may credit the consumer's account automatically or manually. In other embodiments, the customer's account is credited in other units, in lieu of, or in addition to, milligrams. The unit of credit may be dependent on the type of precious metal.

Furthermore, the GDC employee may be able to provide a cash value for the gold (based for example, on prior day's spot price. The GDC employee may be provided with a tool or feature on the website to determine the value of the gold in the requested currency. Further, the GDC employee may notify the consumer about the credit and/or the system itself may automatically notify the consumer about the credit.

Communication with Financial Institution

The GDC employee may be provided with a tool or feature to electronically communicate with a financial institution in real time. For example, the GDC website may provide the GDC employee with a tool or feature to electronically set-up a sweep account (or another account) with the financial institution (such as a “sweep account” tab or button on the GDC interface). Preferably, the sweep account is created at a bank in the customer's country of residence. This sweep account (or other account) may be set-up with the financial institution at any time in the process. If the consumer already has a sweep account, that account may be used, or another one may be created at the consumer's request. For example, the sweep account may be set-up in the consumer's name (if the consumer does not already have one) after his or her request of the gold packet. In this regard, the request of the gold packet may trigger the system to set-up a sweep account with the financial institution. The sweep account may show zero cash balance but funds may be available equal to the cash value of the gold at GDC or its partner repository. Once the consumer is set-up with a sweep account, the GDC employee may be provided with a tool or feature to electronically communicate that credit (in cash value and/or units precious metal, such as milligrams), preferably in real time, to the financial institution.

Either before or after the credit is communicated to the financial institution, the GDC employee may be provided with a tool or feature on the GDC employee GUI to electronically communicate the credit (in cash value and/or units precious metal, such as milligrams) to the consumer.

This communication may signal to the consumer that the debit card is credited (or otherwise “secured”), and the consumer may thereby use it to make a financial transaction with a merchant (as a debit card and/or as a secure credit card). The merchant may receive credit in local currency. In this manner, the consumer may use the debit card while travelling out-of-country (i.e., if the card is used with a merchant in France, then the merchant may receive credit in French currency). The merchant may process payment through the existing banking infrastructure (for example, but not limited to, Interbank Networks, Cirrus & Plus, or other card processing vendors) as any ordinary debit card purchase. A debit may thereby be created with the bank having the customer's sweep account.

The GDC employee may be provided with a feature or tool (i.e., a “view transaction history” selection) on the GDC website to determine the charges made to the gold debit card and/or the system may update to reflect a transaction on the customer's account. Customer transactions may be stored in a customer transaction database. A debit may thereby show on the consumer's sweep account at the financial institution. The financial institution may, in turn, electronically communicate with the GDC agency or the GDC lending facility, and the financial institution may thereby receive a credit from the GDC agency or the GDC lending facility.

Additionally, the GDC employee may be provided with an online tool or feature (such as a feature to aggregate debits and calculate milligrams remaining based upon the transaction day's spot price) to aggregate all debits on a particular consumer's account after a certain amount of time and/or after a certain percentage of credit (in cash value or units of precious metal, such as milligrams of gold) is used by the consumer. Preferably, each customer's debits are aggregated on a daily basis. In this regard, the GDC employee may select, for example, an “update” button to determine the milligrams of gold remaining in a particular customer's accounts after all of the day's financial transactions (for that particular customer) are aggregated. The tool or feature may flag or otherwise notify the GDC employee, when for example, 90% of a consumer's credit is used by the consumer. This notification may trigger the GDC employee to sell enough gold to credit the GDC agency or its lending facility. Additionally, all debits of all customer accounts may be aggregated, or added together, daily, or at any other time interval. In this manner, hundreds of debits may exist, but only a few ounces may be sold to the gold dealer or other entity. Preferably, the amount of gold sold is equal to, or substantially equal to, the total amount of all of the debits of all of the customer accounts on any given day.

The gold may be sold to a gold and bullion dealer or other entity. The gold and bullion dealer may wire funds to the financial institution to place the sweep account in a “zero” balance. In some embodiments, the GDC employee may sell enough gold immediately upon credit to the consumer's account (without waiting for the credit to be used by the consumer).

The following example is presented to enable those skilled in the art to understand and practice the invention and to identify the presently preferred embodiments thereof. This example is presented for illustrative purposes only and not to indicate the scope of the invention which is defined only by the appended claims.

### Example

In one embodiment, gold is credited and debited to the customer account in the following manner: (Note: One Troy Ounce=31,103.4768 milligrams)
1. Customer deposits 1 Troy Ounce of gold (when gold is $1600/Troy Ounce):
   Balance: 31, 103.4768 milligrams are deposited into customer account
   Cash value of account: $1600 at the time of deposit
      a. Customer used debit card at merchant to make $100 purchase (when gold is at $1600/Troy Ounce):
         Balance: 29,159.4644 milligrams remain in customer account after $100 purchase (using $0.05144 per 1 milligram)
      b. Customer used debit card at merchant to make $100 purchase (when gold is at $1800/Troy Ounce):
         Balance: 29,375.4658 milligrams remain in customer account after $100 purchase (using $0.05787 per 1 milligram)

The foregoing embodiments are merely examples of the present invention. Those skilled in the art may make numerous uses of, and departures from, such embodiments without departing from the scope of the present invention. Accordingly, the scope of the present invention is not limited to, or defined by, such embodiments in any way, but rather, is defined solely by the following claims.

What is claimed is:

1. A computer-implemented method for facilitating financial transactions in one or more precious metals using a debit card secured by the one or more precious metals, comprising:
a. using an Internet website accessible via a computer or a mobile device, wherein the Internet website is configured to perform the steps of:
i. providing a first customer with a first balance of a first customer account; wherein the first balance is provided in weight of the one or more precious metals provided by the first customer.

2. The computer-implemented method of claim 1, wherein the one or more precious metals is gold.

3. The computer-implemented method of claim 2, wherein weight of gold is provided in milligrams.

4. The computer-implemented method of claim 3, wherein the Internet website is configured to perform the step of receiving information regarding the first customer's use of a first debit card, wherein the first debit card is secured by gold.

5. The computer-implemented method of claim 4, wherein the Internet website is configured to perform the step of updating the first balance to a second balance, wherein the second balance reflects a first debit with the debit card, wherein the second balance is provided in milligrams of gold.

6. The computer-implemented method of claim 5, wherein the second balance is determined by value of gold on the day the first debit occurred.

7. The computer-implemented method of claim 6, wherein the Internet website is configured to provide a second customer with a third balance of a second customer account; wherein the third balance of the second customer account is provided to the second customer in milligrams of gold.

8. The computer-implemented method of claim 7, further compromising the step of updating the third balance to a fourth balance, wherein the fourth balance reflects a second debit with a second debit card, wherein the fourth balance is provided to the second customer in milligrams of gold.

9. The computer-implemented method of claim 8, wherein Internet website is configured to perform the step of aggregating the first debit and the second debit to form a total; wherein the total is converted to milligrams of gold.

10. The computer-implemented method of claim 9, wherein the Internet website is configured to determine an amount of gold to be sold daily, wherein the amount is equal to the total of the first debit and the second debit.

11. The computer-implemented method of claim 10, wherein the Internet web site is configured to perform the step of aggregating the first debit and the second debit daily.

12. The computer-implemented method of claim 11, wherein the Internet web site is configured to electronically communicate with the first customer's sweep account, or the second customer's sweep account, at a financial institution.

13. The computer-implemented method of claim 12, wherein the Internet web site is configured to deduct milligrams of gold based upon a current day's spot price or a prior day's gold spot price.

14. The computer-implemented method of claim 14, wherein the Internet website is configured to notify the first customer about milligrams of gold deducted from the first customer account based upon the first debit.

15. The computer-implemented method of claim 14, wherein the Internet web site is configured to update the first customer account to reflect an additional gold provided by the first customer; wherein a value of the additional gold is determined by date of credit of the additional gold to the first customer's account; wherein the first customer account is credited in milligrams of gold.

16. A computer-implemented method of facilitating one or more financial transactions in gold, compromising:
a. using an Internet website accessible by a computer or mobile device;
b. providing gold;
c. establishing a customer account; and
d. receiving a first balance of the customer account in milligrams of gold.

17. The computer-implemented method of claim 16, further compromising the step of receiving conducting a financial transaction with a debit card, wherein the financial transaction results in a debit, wherein the debit is reflected in a second balance on the customer's account, wherein the second balance is provided in milligrams of gold.

18. A computer-implemented method of conducting financial transactions in small amounts of gold, compromising:
a. using an Internet website accessible via a computer or a mobile device; wherein the Internet website is configured to:
i. update a customer account to reflect a debit with a debit card; and
ii. determine an amount of gold to sell daily, wherein the amount of gold is equal to an amount of the debit.
